(19) United States
(12) Patent Application Publication
(10) Pub. No.: US 2026/0331349 A1
(43) Pub. Date: Oct. 22, 2026

(54) Modular Transformer and Fabrication Process

(71) Applicant: Magroots Technology Corporation, Tokyo (JP)

(72) Inventors: Kakuryo Sho, Kawagoe (JP); Chunyang Guan, Kawagoe (JP)

(21) Appl. No.: 19/183,898

(22) Filed: Apr. 20, 2025

(51) Int. Cl. H01F 27/02; H01F 27/28; H01F 41/061

(52) U.S. Cl. CPC H01F 27/025; H01F 27/2823; H01F 41/061

(57) ABSTRACT

A modular transformer includes a central magnetic core pillar, a first inner heat sink, wherein a core-contacting portion wraps around the central magnetic core pillar, a first winding wound around the central magnetic core pillar, wherein the first inner heat sink is between the first winding and the central magnetic core pillar, a second winding wound around the central magnetic core pillar, wherein the first winding is between the second winding and the central magnetic core pillar, a first outer heat sink over the second winding, wherein an extended portion of the first inner heat sink is in direct contact with the first outer heat sink, and a plurality of magnetic core portions located around an outer perimeter of the second winding, wherein the central magnetic core pillar and the plurality of magnetic core portions form a magnetic path of the modular transformer.

### TECHNICAL FIELD

The present invention relates to a modular transformer, and in particular to a modular transformer structure in the field of high-power applications.

### BACKGROUND

The rapid advancement of graphics processing units, neural processing units, and other chip technologies has enabled the widespread development of intelligent applications such as autonomous driving for electric vehicles, robotics, and unmanned aerial vehicles. These technologies are transforming modern life at an unprecedented pace, delivering substantial scientific productivity gains. However, this surge in artificial intelligence (AI) computing power demands has also led to a corresponding increase in power consumption, making electrical power supply a critical bottleneck in the evolution of AI capabilities.

To support these high-performance chips, electrical energy is typically converted from high-voltage AC in the power grid to high-voltage DC levels of 800V or 400V. This high-voltage DC is then stepped down through isolated high-frequency DC-DC converters to intermediate voltage levels around 50V. Subsequently, one or more power conversion stages further reduce the voltage to sub-1V levels suitable for direct use by graphics processing units and neural processing units, while simultaneously delivering large output currents. This multi-stage power conversion architecture forms the backbone of modern data center power supply systems.

A key limiting factor in improving the power conversion efficiency and power density of these DC-DC converters is the high-frequency power transformer used to step down from the 800V/400V DC bus to 50V DC. To address this challenge, inductor-inductor-capacitor (LLC) and dual active bridge (DAB) converter topologies are widely adopted. The transformers employed in these topologies typically support power ratings from several kilowatts to tens of kilowatts and operate at switching frequencies ranging from tens to hundreds of kilohertz. These high-frequency transformers generally use ferrite magnetic cores, with the high-voltage primary winding composed of magnet wires with enhanced insulation films. The 50V low-voltage secondary winding is typically formed using magnet wires or copper plates.

Conventional transformer manufacturing processes impose significant limitations on heat dissipation from the windings. As a result, kilowatt-level high-frequency transformers occupy a considerable amount of space in power conversion systems, forming a major obstacle to further improvement in power density.

To overcome these limitations, the present disclosure introduces a novel high-frequency transformer manufacturing process aimed at achieving ultra high-power density. By designing efficient thermal conduction paths within the transformer and adopting integrated molding techniques using resin materials such as polybutylene terephthalate (PBT) and polyphenylene sulfide (PPS), various embodiments of the present disclosure significantly improve the thermal conduction capability of the windings. Heat generated by the windings is directly channeled to external high thermal conductivity components, such as copper plates, aluminum plates, or ceramic substrates. The new transformer structure thus achieves a power density several times greater than that of conventional transformers.

### SUMMARY

These and other problems are generally solved or circumvented, and technical advantages are generally achieved, by preferred embodiments of the present disclosure which provide a modular transformer for high-power applications.

In accordance with an embodiment, an apparatus comprises a central magnetic core pillar, a first inner heat sink including a core-contacting portion, a vertical portion and an extended portion, wherein the core-contacting portion wraps around a first portion of the central magnetic core pillar, a first winding wound around the central magnetic core pillar, wherein the first inner heat sink is between the first winding and the central magnetic core pillar, a second winding wound around the central magnetic core pillar, wherein the first winding is between the second winding and the central magnetic core pillar, a first outer heat sink over the second winding, wherein the vertical portion of the first inner heat sink is adjacent to outermost turns of the first winding and the second winding, and the extended portion of the first inner heat sink is in direct contact with the first outer heat sink, and a plurality of magnetic core portions located around an outer perimeter of the second winding, wherein the central magnetic core pillar and the plurality of magnetic core portions form a magnetic path of a transformer.

In accordance with another embodiment, a system comprises a primary switch network coupled to an input voltage source, a secondary switch network coupled to a filter, and a modular transformer having a first terminal and a second terminal connected to the primary switch network, and a third terminal and a fourth terminal connected to the secondary switch network, wherein the modular transformer comprises a central magnetic core pillar, a first inner heat sink including a core-contacting portion, a vertical portion and an extended portion, wherein the core-contacting portion wraps around a first portion of the central magnetic core pillar, a first winding wound around the central magnetic core pillar, wherein the first inner heat sink is between the first winding and the central magnetic core pillar, a second winding wound around the central magnetic core pillar, wherein the first winding is between the second winding and the central magnetic core pillar, a first outer heat sink over the second winding, wherein the vertical portion of the first inner heat sink is adjacent to outermost turns of the first winding and the second winding, and the extended portion of the first inner heat sink is in direct contact with the first outer heat sink, and a plurality of magnetic core portions located around an outer perimeter of the second winding, wherein the central magnetic core pillar and the plurality of magnetic core portions form a magnetic path of a transformer.

In accordance with yet another embodiment, a method comprises wrapping a first inner heat sink around a central magnetic core pillar, winding a first wire around the central magnetic core pillar to form a first winding, winding a second wire around the central magnetic core pillar, over the first winding, to form a second winding, attaching a first outer heat sink over the second winding, forming a winding section through performing a pressing process and a first injection molding process, wherein in the pressing process, the first winding and the second winding are deformed into a desired shape, and a bendable portion of the first inner heat sink is bent to be in direct contact with the first outer heat sink, and in the first molding process, a first molding material is applied to the winding section to encapsulate components and fill gaps within the winding section, and by performing a second injection molding process, forming a modular transformer comprising the winding section and a plurality of magnetic core portions surrounding the winding section, wherein in the second molding process, a second molding material encapsulates the winding section and the plurality of magnetic core portions, and fills gaps within the modular transformer, and wherein the first molding material and the second molding material are the same or different.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an external appearance of a modular transformer in accordance with various embodiments of the present disclosure;

FIG. 2 illustrates a bottom view of the modular transformer shown in FIG. 1 in accordance with various embodiments of the present disclosure;

FIG. 3 is an exploded view of the modular transformer shown in FIG. 1 after removing the injection molding material, illustrating the internal structure of the modular transformer in accordance with various embodiments of the present disclosure;

FIG. 4 is a perspective view of the winding section incorporating a heat-dissipative structure in accordance with various embodiments of the present disclosure;

FIG. 5 illustrates the configuration of the internal heat sinks and the central magnetic core pillar within the winding section in accordance with various embodiments of the present disclosure;

FIG. 6 illustrates the configuration of the outer heat sinks and the windings in accordance with various embodiments of the present disclosure;

FIG. 7 is a cross-sectional view of the modular transformer shown in FIG. 1 in accordance with various embodiments of the present disclosure;

FIG. 8 is a perspective view of a central magnetic core pillar and a plurality of heat sinks attached to the central magnetic core pillar in accordance with various embodiments of the present disclosure;

FIG. 9 is a perspective view of the magnetic device shown in FIG. 8 after two windings are wound around the central magnetic core pillar in accordance with various embodiments of the present disclosure;

FIG. 10 is a perspective view of the magnetic device shown in FIG. 9 after two outer heat sinks are wound around the windings in accordance with various embodiments of the present disclosure;

FIG. 11 is a perspective view of the magnetic device shown in FIG. 10 after four inner heat sinks have been bent in accordance with various embodiments of the present disclosure;

FIG. 12 is a perspective view of the magnetic device shown in FIG. 11 after a force pressing process is applied to the windings in accordance with various embodiments of the present disclosure;

FIG. 13 is a perspective view of the magnetic device shown in FIG. 12 after a first injection molding process is applied to the winding section in accordance with various embodiments of the present disclosure;

FIG. 14 is a perspective view of the magnetic device shown in FIG. 12 upon completion of the first injection molding process in accordance with various embodiments of the present disclosure;

FIG. 15 is a perspective view of the magnetic device shown in FIG. 14 after a second injection molding process is applied to the winding section in accordance with various embodiments of the present disclosure;

FIG. 16 is a perspective view of the magnetic device shown in FIG. 15 upon completion of the second injection molding process in accordance with various embodiments of the present disclosure;

FIG. 17 illustrates a cross-sectional view of a first implementation variation of the inner heat sink in accordance with various embodiments of the present disclosure;

FIG. 18 illustrates a cross-sectional view of a second implementation variation of the inner heat sink in accordance with various embodiments of the present disclosure;

FIG. 19 illustrates a cross-sectional view of a third implementation variation of the inner heat sink in accordance with various embodiments of the present disclosure;

FIG. 20 illustrates a cross-sectional view of a fourth implementation variation of the inner heat sink in accordance with various embodiments of the present disclosure;

FIG. 21 illustrates a cross-sectional view of a fifth implementation variation of the inner heat sink in accordance with various embodiments of the present disclosure;

FIG. 22 illustrates a cross-sectional view of a sixth implementation variation of the inner heat sink in accordance with various embodiments of the present disclosure;

FIG. 23 illustrates a first arrangement of an inner heat sink and an outer heat sink in accordance with various embodiments of the present disclosure;

FIG. 24 illustrates a second arrangement of an inner heat sink and an outer heat sink in accordance with various embodiments of the present disclosure;

FIG. 25 illustrates a top view of a first arrangement of inner heat sinks and the central magnetic core pillar in accordance with various embodiments of the present disclosure;

FIG. 26 illustrates a top view of a second arrangement of inner heat sinks and the central magnetic core pillar in accordance with various embodiments of the present disclosure;

FIG. 27 illustrates a top view of a third arrangement of inner heat sinks and the central magnetic core pillar in accordance with various embodiments of the present disclosure;

FIG. 28 illustrates a top view of a fourth arrangement of inner heat sinks and the central magnetic core pillar in accordance with various embodiments of the present disclosure;

FIG. 29 illustrates a schematic diagram of a power converter including a modular transformer in accordance with various embodiments of the present disclosure; and

FIG. 30 illustrates a flow chart of a method for fabricating the modular transformer shown in FIG. 1 in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to preferred embodiments in a specific context, namely a modular transformer for high-power applications. The disclosure may also be applied, however, to a variety of power conversion systems. Hereinafter, various embodiments will be explained in detail with reference to the accompanying drawings.

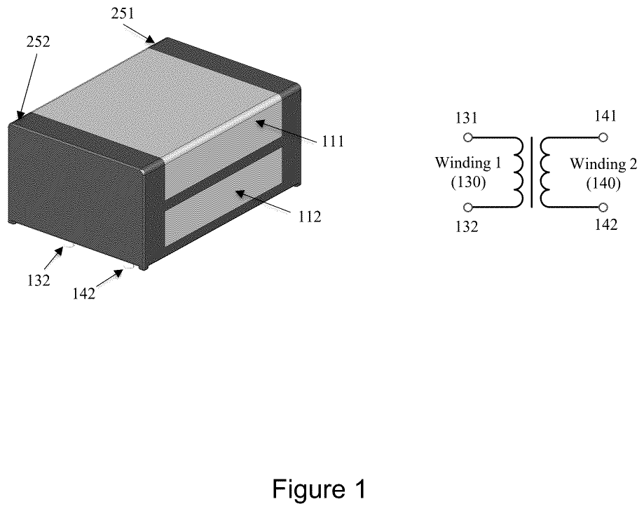

FIG. 1 illustrates an external appearance of a modular transformer in accordance with various embodiments of the present disclosure. The modular transformer has a rectangular cuboid shape. As shown in FIG. 1, the bottom, the front side surface and the rear side surface of the modular transformer are designed as molding material surfaces. The left side surface, the top surface, and the right side surface of the modular transformer are designed as heat dissipation surfaces composed of high thermal conductivity materials. In practical applications, these heat dissipation surfaces are intended to be in direct contact with an external heat sink to facilitate efficient thermal exchange with an external cooling system associated with a power conversion system.

As shown in FIG. 1, the modular transformer includes a first heat sink 111 and a second heat sink 112 positioned on its top and side surfaces to enhance heat dissipation. As shown in FIG. 1, a gap is between the first heat sink 111 and the second heat sink 112. This gap is filled with a suitable molding material.

The first heat sink 111 and the second heat sink 112 are made of thermally conductive materials such as copper, aluminum, ceramic, or other suitable equivalents. These heat dissipation surfaces allow for efficient transfer of heat generated by the internal components, thereby improving the overall thermal management of the modular transformer. Throughout the description, the first heat sink 111 may be alternatively referred to as a first exposed heat sink. The second heat sink 112 may be alternatively referred to as a second exposed heat sink.

In some embodiments, the insulation between the heat dissipation surfaces and the internal windings, as well as insulation between windings, is achieved through the inherent insulation layer of the winding wires. As shown in FIG. 1, the modular transformer comprises a first winding terminal 132 and a second winding terminal 142, which provide electrical connections for input and output power transmission while maintaining electrical insulation from the heat dissipation surfaces.

In some embodiments, the heat dissipation surfaces are partially embedded in a plastic encapsulation material using an injection molding process, such as Polyphenylene Sulfide (PPS), Polyethylene Terephthalate (PET), Polybutylene Terephthalate (PBT), or the like. To ensure reliable and effective embedding, a significant portion of the heat dissipation surfaces remains exposed, while part of the edges of the heat dissipation plates may be embedded within the plastic encapsulation. The molding material formed regions 251 and 252 contribute to the structural integrity and insulation of the modular transformer, ensuring the secure integration of the heat dissipation surfaces within the encapsulation.

As shown in FIG. 1, the exposed heat dissipation surfaces are designed for external thermal conduction. Portions of the magnetic core material or transformer terminals are exposed as needed. The remaining exterior surfaces of the modular transformer are formed from an integrally molded plastic resin. This encapsulated structure provides mechanical protection, electrical insulation, and durability, making the modular transformer suitable for high-efficiency power conversion applications.

FIG. 1 further illustrates an equivalent circuit of the modular transformer. As shown in FIG. 1, the modular transformer comprises a first winding 130 and a second winding 140 magnetically coupled to each other. The first winding 130 has two terminals 131 and 132. The second winding 140 has two terminals 141 and 142.

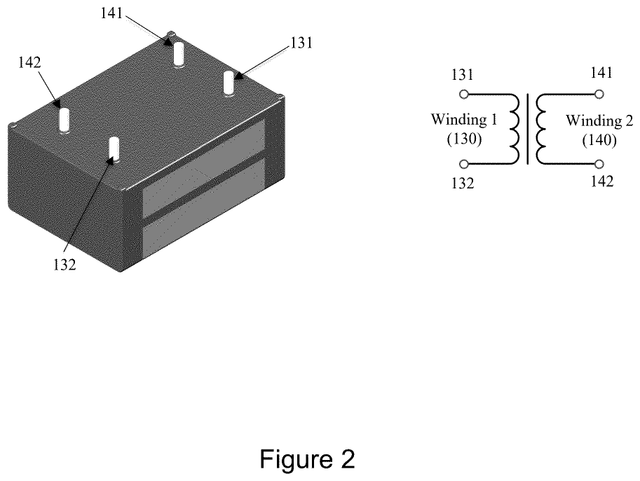

FIG. 2 illustrates a bottom view of the modular transformer shown in FIG. 1 in accordance with various embodiments of the present disclosure. As illustrated in FIG. 2, when the bottom side heat dissipation is not required, the exposed bottom surface of the modular transformer—excluding regions accommodating necessary winding terminals 131, 132, 141 and 142—is formed from a molding material. This configuration provides electrical insulation and mechanical protection while preserving the structural integrity of the modular transformer.

The modular transformer, as shown in FIG. 2, comprises a first winding 130 (Winding 1) and a second winding 140 (Winding2). In some embodiments, the windings are arranged to optimize electrical performance while maintaining insulation and efficient heat dissipation through the designated surfaces.

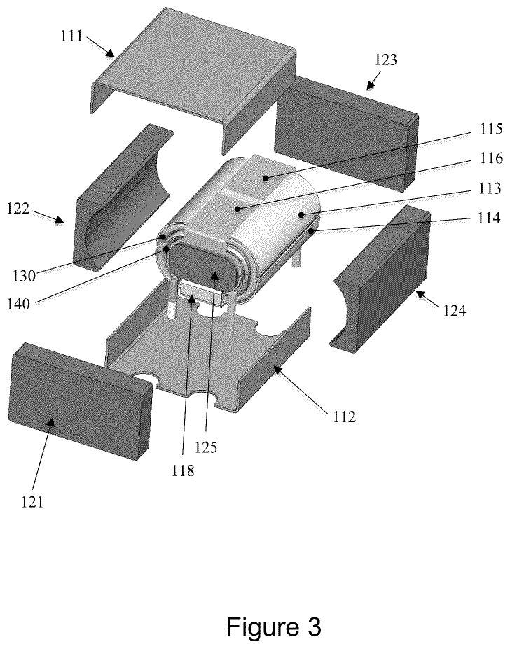

FIG. 3 is an exploded view of the modular transformer shown in FIG. 1 after removing the injection molding material, illustrating the internal structure of the modular transformer in accordance with various embodiments of the present disclosure. The modular transformer comprises a winding section incorporating a heat-dissipative structure, a plurality of magnetic core portions and two exposed heat sinks. In some embodiments, the winding section comprises a central magnetic core pillar, a first winding 140, a second winding 130, a plurality of internal heat sinks (a fifth heat sink 115, a sixth heat sink 116, a seventh heat sink 117 and an eighth heat sink 118), and a plurality of outer heat sinks (a third heat sink 113 and a fourth heat sink 114). The plurality of internal heat sinks and the plurality of outer heat sinks form the heat-dissipative structure.

As shown in FIG. 3, the magnetic core inside the modular transformer is divided into five core portions, namely a first core portion 121, a second core portion 122, a third core portion 123, a fourth core portion 124 and a fifth core portion 125. As shown in FIG. 3, the first core portion 121, the second core portion 122, the third core portion 123 and the fourth core portion 124 are positioned around the outer perimeter of the windings 130 and 140. The fifth core portion 125 functions as a winding core on which the wires of the modular transformer are wound.

As shown in FIG. 3, the first core portion 121 is a first cuboid-shaped magnetic element configured to connect to a first terminal of the winding core, which corresponds to the fifth core portion 125. The second core portion 122 includes a planar outer sidewall and an inner sidewall contoured to match the profile of the winding section. The third core portion 123 is a second cuboid-shaped magnetic element configured to connect to a second terminal of the winding core (the fifth core portion 125). The fourth core portion 124 includes a planar outer sidewall and an inner sidewall contoured to match the profile of the winding section. Throughout the description, the first core portion 121 is alternatively referred to as a first terminal core portion 121. The second core portion 122 is alternatively referred to as a first sidewall core portion 122. The third core portion 123 is alternatively referred to as a second terminal core portion 123. The fourth core portion 124 is alternatively referred to as a second sidewall core portion 124. The fifth core portion 125 is alternatively referred to as a central magnetic core pillar 125.

In operation, when current flows through the windings, magnetic flux is generated in the central magnetic core pillar 125. As shown in FIG. 3, the central magnetic core pillar 125 is surrounded by the windings. The flux then flows outward through the first terminal core portion 121, the first sidewall core portion 122, the second sidewall core portion 124 and the second terminal core portion 123 before returning to the central magnetic core pillar 125, forming a complete magnetic circuit for the modular transformer.

As shown in FIG. 3, the third heat sink 113, the fourth heat sink 114, the fifth heat sink 115, the sixth heat sink 116, the seventh heat sink 117 and the eighth heat sink 118 are six heat sinks in the winding section. The heat sinks in the winding section are made of thermally conductive materials such as copper, aluminum, ceramic, or other suitable equivalents. The third heat sink 113 is in contact with the upper surface of the winding 130. The fourth heat sink 114 is in contact with the lower surface of the winding 130. The fifth heat sink 115 and the sixth heat sink 116 have three portions. A first portion is placed between the central magnetic core pillar 125 and the winding 140. A second portion is over and in contact with the third heat sink 113. A third portion is a bent portion connected between the first portion and the second portion. The seventh heat sink 117 and the eighth heat sink 118 also have three portions. A first portion is placed between the central magnetic core pillar 125 and the winding 140. A second portion is over and in contact with the fourth heat sink 114. A third portion is a bent portion connected between the first portion and the second portion. During the injection molding process, the two external heat sinks 111 and 112 are tightly encapsulated within the plastic material, ensuring firm contact with the heat sinks 113, 114, 115, 116, 117 and 118.

As shown in FIG. 3, the modular transformer further includes a first exposed heat sink 111 and a second exposed heat sink 112. In the completed modular transformer, a center portion of the first exposed heat sink 111 is in direct contact with the extended portion of the first inner heat sink 115 and the extended portion of the second inner heat sink 116. A first sidewall portion of the first exposed heat sink 111 is in direct contact with the first sidewall core portion 122. A second sidewall portion of the first exposed heat sink 111 is in direct contact with the second sidewall core portion 124.

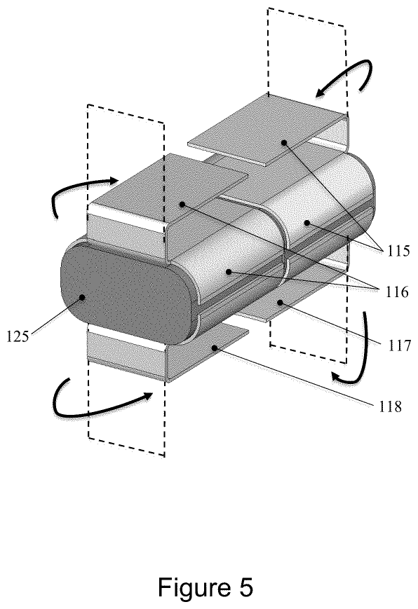

A center portion of the second exposed heat sink 112 is in direct contact with the extended portion of the third inner heat sink 117 and the extended portion of the fourth inner heat sink 118 (not shown, but illustrated in FIG. 5). As shown in FIG. 3, the center portion of the second exposed heat sink 112 has four openings through which the terminals of the windings pass and are accessible outside the modular transformer. A first sidewall portion of the second exposed heat sink 112 is in direct contact with the first sidewall core portion 122. A second sidewall portion of the second exposed heat sink 112 is in direct contact with the second sidewall core portion 124.

It should be noted that in some applications where extreme heat dissipation is not required, the first heat sink 111 can be removed, or both the first heat sink 111 and the second heat sink 112 can be omitted. In such cases, the heat sinks (heat sinks 113, 114, 115, 116, 117 and 118) are directly exposed on the outer surface of the molded housing of the modular transformer, thereby reducing the overall cost of the modular transformer.

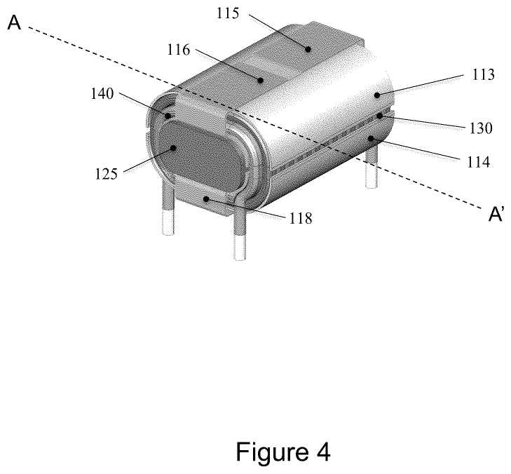

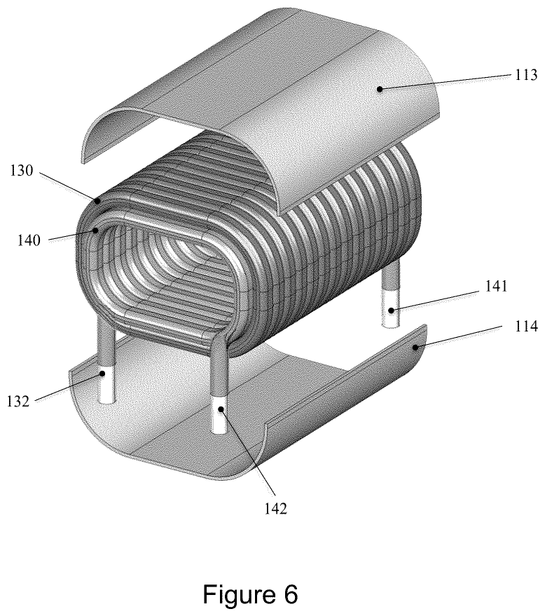

FIG. 4 is a perspective view of the winding section incorporating a heat-dissipative structure in accordance with various embodiments of the present disclosure. FIG. 5 illustrates the configuration of the internal heat sinks and the central magnetic core pillar within the winding section in accordance with various embodiments of the present disclosure. FIG. 6 illustrates the configuration of the outer heat sinks and the windings in accordance with various embodiments of the present disclosure.

As shown in FIG. 4, the third heat sink 113 and the fourth heat sink 114 are outer heat sinks in the winding section. More particularly, the third heat sink 113 wraps around an upper portion of the winding 130. The fourth heat sink 114 wraps around a lower portion of the winding 130. Throughout the description, the third heat sink 113 is alternatively referred to as a first outer heat sink 113. The fourth heat sink 114 is alternatively referred to as a second outer heat sink 114.

As shown in FIG. 5, the heat sinks 115, 116, 117 and 118 are four thin internal heat-dissipating plates that wrap around the central magnetic core pillar 125. In some embodiments, each of the four heat sinks is individually bonded to the magnetic core at distinct locations-specifically, the upper left, upper right, bottom left, and bottom right surfaces of the core-using thermally conductive adhesive. In alternative embodiments, each heat sink is dimensioned slightly smaller than the corresponding surface of the magnetic core. During the assembly process, a pressing step is applied, causing the heat sinks to elastically deform and securely snap into place around the central magnetic core pillar 125, effectively wrapping the core surfaces and ensuring firm thermal contact without the need for adhesives.

Throughout the description, the fifth heat sink 115 is alternatively referred to as a first inner heat sink 115. The sixth heat sink 116 is alternatively referred to as a second inner heat sink 116. The seventh heat sink 117 is alternatively referred to as a third inner heat sink 117. The eighth heat sink 118 is alternatively referred to as a fourth inner heat sink 118.

As shown in FIGS. 4-5, the first inner heat sink 115 includes a core-contacting portion, a vertical portion and an extended portion. The core-contacting portion of the first inner heat sink 115 wraps around an upper right portion of the central magnetic core pillar 125. The extended portion of the first inner heat sink 115 is in direct contact with the first outer heat sink 113. The second inner heat sink 116 includes a core-contacting portion, a vertical portion and an extended portion. The core-contacting portion of the second inner heat sink 116 wraps around an upper left portion of the central magnetic core pillar 125. The extended portion of the second inner heat sink 116 is in direct contact with the first outer heat sink 113. The third inner heat sink 117 includes a core-contacting portion, a vertical portion and an extended portion. The core-contacting portion of the third inner heat sink 117 wraps around a lower right portion of the central magnetic core pillar 125. The extended portion of the third inner heat sink 117 is in direct contact with the second outer heat sink 114. The fourth inner heat sink 118 includes a core-contacting portion, a vertical portion and an extended portion. The core-contacting portion of the fourth inner heat sink 118 wraps around a lower left portion of the central magnetic core pillar 125. The extended portion of the fourth inner heat sink 118 is in direct contact with the second outer heat sink 114.

The configuration of the inner heat sinks and the outer heat sinks shown in FIGS. 4-5 ensures that the heat from the inner heat-dissipating plates (e.g., inner heat sinks 115-118) can be effectively conducted outward from the internal portion of the winding section. By contacting the outer heat-dissipating plates (e.g., outer heat sinks 113-114) surrounding the windings, the winding section shown in FIG. 4 enables internal heat to be efficiently transferred to the exterior via the high thermal conductivity metal plates. For this purpose, the bending portion of the heat-dissipating plates are matched with flat-surface designs on the central magnetic core pillar 125. It should be noted that in cases where it is not necessary to bend the internal heat-dissipating plates, the surfaces of the central magnetic core pillar 125 may alternatively be designed with an arc shape.

As shown in FIG. 5, the configuration of the inner heat sinks prevents the formation of a closed-loop short circuit. More particularly, four inner heat sinks 115-118 are attached to the central magnetic core pillar 125, each inner heat sink being spaced apart from the others. As shown in FIG. 5, these four inner heat sinks are separated from one another at the central region of the central magnetic core pillar 125. Additionally, the upper inner heat sinks 115 and 116, and the lower inner heat sinks 117 and 118 are also separated at the central arc-shaped surface of the central magnetic core pillar 125, ensuring that the four inner heat sinks used for thermal conduction remain electrically isolated at their core sections and do not create a short circuit.

As indicated by FIGS. 5-6, two transformer windings 130 and 140 are tightly wound around the thin heat-dissipating plates (inner heat sinks 115, 116, 117 and 118) on the outer side of the central magnetic core pillar 125. In practical applications, the windings 130 and 140 may be wound using wires of different thicknesses and different numbers of turns. Either winding can serve as the primary winding of the transformer in accordance with the present disclosure.

As shown in FIG. 6, this structure is further enclosed by two heat-dissipating plates (outer heat sinks 113 and 114) that closely cover the outer surfaces of the windings 130 and 140.

As shown in FIG. 5, to avoid interfering with the winding process, portions of the internal heat-dissipating plates (inner heat sinks 115, 116, 117 and 118) are pre-formed into L-shapes as indicated by the dashed lines in FIG. 5. After both windings 130 and 140 are formed, the dashed line portions of these heat-dissipating plates are bent into their final L-shaped configurations as shown in FIGS. 4-5.

In some embodiments, the windings are formed using Litz wires, which consist of multiple strands of individually insulated conductors. To accommodate various turns ratios and application-specific requirements, the windings may be implemented using round wire, flat multi-stranded Litz wire, or multiple wires wound in parallel.

In order to efficiently transfer heat from the windings to the heat-dissipating plates through direct contact over a maximized surface area, each of the two windings 130 and 140, is implemented with a single winding layer. This configuration ensures that at least one side of each winding is always in direct contact with either the inner heat-dissipating plates (e.g., inner heat sinks 115-118) or outer heat-dissipating plates (e.g., outer heat sinks 113-114).

To further reduce the volume of the transformer windings while ensuring that heat sinks 113-118 remain in close thermal contact with the windings 130 and 140, a high-temperature and high-pressure injection molding process is employed using plastic resin materials such as PPS, PBT and the like. Before the molten resin is injected, the heat-dissipating plates (e.g., heat sinks 113-118) and windings are tightly compressed within the injection mold, and the windings 130 and 140 are significantly compressed and flattened.

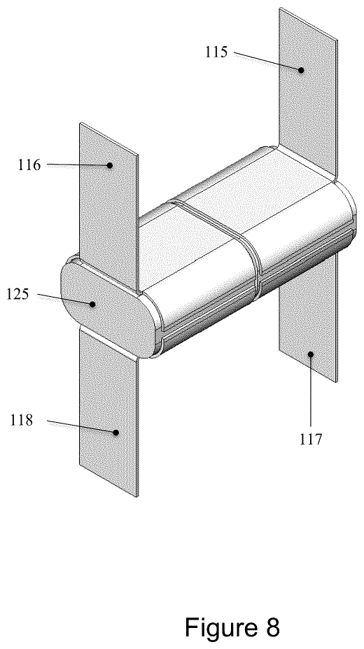

Once compressed between the internal and external thin heat-dissipating plates, the windings 130 and 140 are encapsulated with high-temperature molten resin injected at a pressure of tens of megapascals (MPa) into the mold cavity, where it is cured under high temperature and pressure. The detailed fabrication process will be described below with respect to FIGS. 8-16.

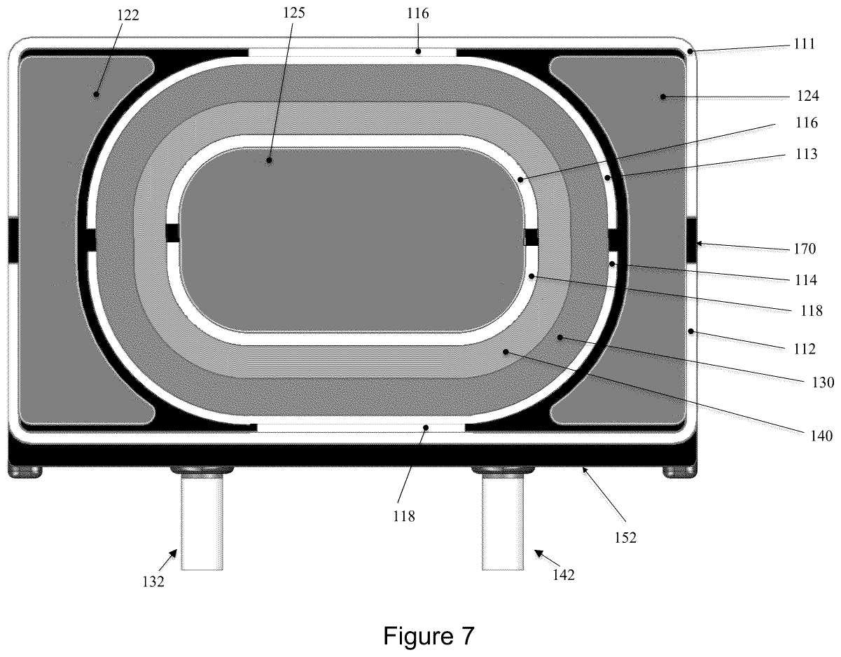

FIG. 7 is a cross-sectional view of the modular transformer shown in FIG. 1 in accordance with various embodiments of the present disclosure. The cross-sectional view of the modular transformer shown in FIG. 7 is taken along the line A-A′ shown in FIG. 4. The cross-sectional view of the modular transformer shown in FIG. 7 illustrates the structure of the modular transformer after completion of the injection molding process. As shown in FIG. 7, the upper portion of the central magnetic core pillar 125 is wrapped by the second inner heat sink 116. The lower portion of the central magnetic core pillar 125 is wrapped by the fourth heat sink 118. The inner heat sinks 116 and 118 are thin heat-dissipating plates as shown in FIG. 5. During the injection molding process, the gaps between the second inner heat sink 116 and the fourth inner heat sink 118 are filled with suitable molding materials.

The winding 140 is tightly wound around the thin heat-dissipating plates (e.g., inner heat sinks 116 and 118). In some embodiments, the winding 140 is implemented as a single-layer winding. In other words, none of the turns of the winding 140 are stacked or positioned on top of one another. Likewise, the winding 130 is tightly wound around the winding 140. In some embodiments, the winding 130 is implemented as a single-layer winding. In other words, none of the turns of the winding 130 are stacked or positioned on top of one another.

As shown in FIG. 7, the upper portion of the winding 130 is wrapped by the first outer heat sink 113. The lower portion of the winding 130 is wrapped by the second outer heat sink 114. The outer heat sinks 113 and 114 are thin heat-dissipating plates as shown in FIG. 6. During the injection molding process, the gaps between the first outer heat sink 113 and the second outer heat sink 114 are filled with suitable molding materials. As shown in FIG. 7, a portion of the second inner heat sink 116 is over and in direct contact with the first outer heat sink 113. Likewise, a portion of the fourth inner heat sink 118 is below and in direct contact with the second outer heat sink 114.

As shown in FIG. 7, in order to enable each winding to achieve optimal heat dissipation through adjacent heat sinks, each winding is designed such that at least one surface of the winding is in close contact with a heat sink, forming a winding section incorporating a heat-dissipative structure. As shown in FIG. 7, the winding section includes the windings 130 and 140 and the associated magnetic core portion (central magnetic core pillar 125). The heat-dissipative structure further includes the heat sinks 113, 114, 115, 116, 117 and 118 (heat sinks 115 and 117 shown in FIG. 5).

As shown in FIG. 7, the first sidewall core portion 122 is placed at the left side of the winding section. During the injection molding process, the gap between the first sidewall core portion 122 and the winding section is filled with suitable molding materials. The second sidewall core portion 124 is placed at the right side of the winding section. During the injection molding process, the gap between the second sidewall core portion 124 and the winding section is filled with suitable molding materials.

The first exposed heat sink 111 is over the first sidewall core portion 122, a left curved portion of the first outer heat sink 113, the upper portion of the second inner heat sink 116, a right curved portion of the first outer heat sink 113 and the second sidewall core portion 124. As shown in FIG. 7, the first exposed heat sink 111 is in direct contact with the upper portion of the second inner heat sink 116. Any gaps between the first exposed heat sink 111 and surrounding areas are filled with appropriate molding materials.

The second exposed heat sink 112 is below the first sidewall core portion 122, a left curved portion of the second outer heat sink 114, the lower portion of the fourth inner heat sink 118, a right curved portion of the second outer heat sink 114 and the second sidewall core portion 124. As shown in FIG. 7, the second exposed heat sink 112 is in direct contact with the lower portion of the fourth inner heat sink 118. Any gaps between the second exposed heat sink 112 and surrounding areas are filled with appropriate molding materials.

As shown in FIG. 7, the gaps between the first exposed heat sink 111 and the second exposed heat sink 112 are filled with appropriate molding materials. A molding compound layer 152 is formed at the bottom side of the modular transformer. The lower portions of the winding terminals 132 and 142 are surrounded by the molding compound layer 152.

FIGS. 8-16 illustrate intermediate steps of fabricating the modular transformer shown in FIG. 1 in accordance with various embodiments of the present disclosure. Throughout the description, each intermediate structure formed during the modular transformer fabrication process may be referred to as a magnetic device.

The fabrication process described below is based upon a single-layer winding structure. However, as one having ordinary skill in the art will recognize that the single-layer winding structure described below is merely an exemplary process and is not meant to limit the various embodiments. Other winding structures such as double-layer or multiple-layer winding structures may alternatively be used. In sum, any suitable winding structures may be used, and all such processes are fully intended to be included within the scope of the embodiments discussed herein.

FIG. 8 is a perspective view of a central magnetic core pillar and a plurality of heat sinks attached to the central magnetic core pillar in accordance with various embodiments of the present disclosure. The central magnetic core pillar 125 has a flat top and a flat bottom. The sidewalls of the central magnetic core pillar 125 have an arc shape.

As shown in FIG. 8, the first inner heat sink 115 includes two portions. A lower portion of the first inner heat sink 115 wraps around an upper-right portion of the central magnetic core pillar 125. An upper portion of the first inner heat sink 115 extends outward above the central magnetic core pillar 125. As shown in FIG. 8, the upper portion and the lower portion of the first inner heat sink 115 form a right angle.

As shown in FIG. 8, the second inner heat sink 116 includes two portions. A lower portion of the second inner heat sink 116 wraps around an upper-left portion of the central magnetic core pillar 125. An upper portion of the second inner heat sink 116 extends outward above the central magnetic core pillar 125. As shown in FIG. 8, the upper portion and the lower portion of the second inner heat sink 116 form a right angle.

As shown in FIG. 8, the third inner heat sink 117 includes two portions. An upper portion of the third inner heat sink 117 wraps around a lower-right portion of the central magnetic core pillar 125. A lower portion of the third inner heat sink 117 extends downward beyond the bottom of the central magnetic core pillar 125. As shown in FIG. 8, the upper portion and the lower portion of the third inner heat sink 117 form a right angle.

As shown in FIG. 8, the fourth inner heat sink 118 includes two portions. An upper portion of the fourth inner heat sink 118 wraps around a lower-left portion of the central magnetic core pillar 125. A lower portion of the fourth inner heat sink 118 extends downward beyond the bottom of the central magnetic core pillar 125. As shown in FIG. 8, the upper portion and the lower portion of the fourth inner heat sink 118 form a right angle.

In some embodiments, the central magnetic core pillar 125 is a ferrite core pillar. The inner heat sinks 115-118 are thin heat-dissipating plates made from thermally conductive materials such as copper, aluminum, ceramic and the like. The inner heat sinks 115-118 are closely attached to the central magnetic core pillar 125. As shown in FIG. 8, the inner heat sinks 115-118 are separated from each other and not electrically shorted.

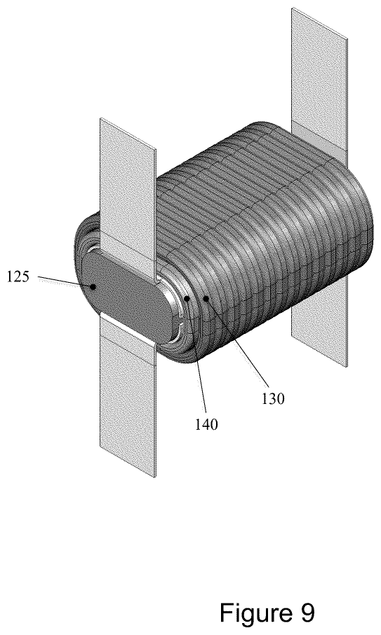

FIG. 9 is a perspective view of the magnetic device shown in FIG. 8 after two windings are wound around the central magnetic core pillar in accordance with various embodiments of the present disclosure. A first wire is wound in a single layer around the central magnetic core pillar 125 to form the winding 140. In some embodiments, the first wire is a single multi-stranded magnet wire. More particularly, the first wire is a round magnet wire, which is arranged and wound neatly around the central magnetic core pillar 125. In alternative embodiments, to accommodate a design capable of handling higher current, the single-layer winding may be formed by winding two or more identical magnet wires in parallel. Alternatively, the round magnet wire may be designed as a flat wire.

Following the completion of the winding 140, a second wire is wound around the central core pillar 125 and over the winding 140 to form the winding 130. The winding 130 is also a single-layer winding. The second wire is similar to the first wire, hence is not discussed herein to avoid repetition.

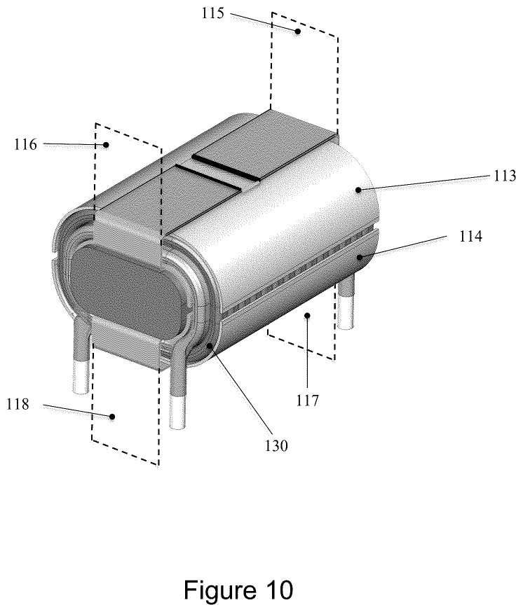

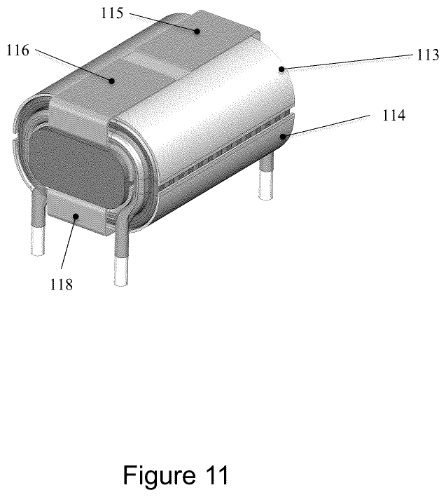

FIG. 10 is a perspective view of the magnetic device shown in FIG. 9 after two outer heat sinks are wound around the windings in accordance with various embodiments of the present disclosure. FIG. 11 is a perspective view of the magnetic device shown in FIG. 10 after four inner heat sinks have been bent in accordance with various embodiments of the present disclosure.

As shown in FIG. 10, the upper portion of the winding 130 is enclosed by the first outer heat sink 113. The lower portion of the winding 130 is enclosed by the second outer heat sink 114. There is a gap between the first outer heat sink 113 and the second outer heat sink 114. In a subsequent fabrication step, the gap will be filled with suitable molding materials.

As shown in FIG. 10, the dashed rectangles indicate the initial positions of the inner heat sinks 115, 116, 117 and 118. As shown in FIG. 11, the upper portions of the inner heat sinks 115 and 116 are bent downward along the surface of the first outer heat sink 113. In particular, the upper portions of the inner heat sinks 115 and 116 are in direct contact with the surface of the first outer heat sink 113. Likewise, the lower portions of the inner heat sinks 117 and 118 are bent upward along the surface of the second outer heat sink 114. In particular, the lower portions of the inner heat sinks 117 and 118 are in direct contact with the surface of the second outer heat sink 114. The direct contacts between the inner heat sinks (e.g., heat sink 115) and the outer heat sinks (e.g., first outer heat sink 113) form a thermal conduction structure that conducts internal heat to the outside through the inner heat sinks and the outer heat sinks.

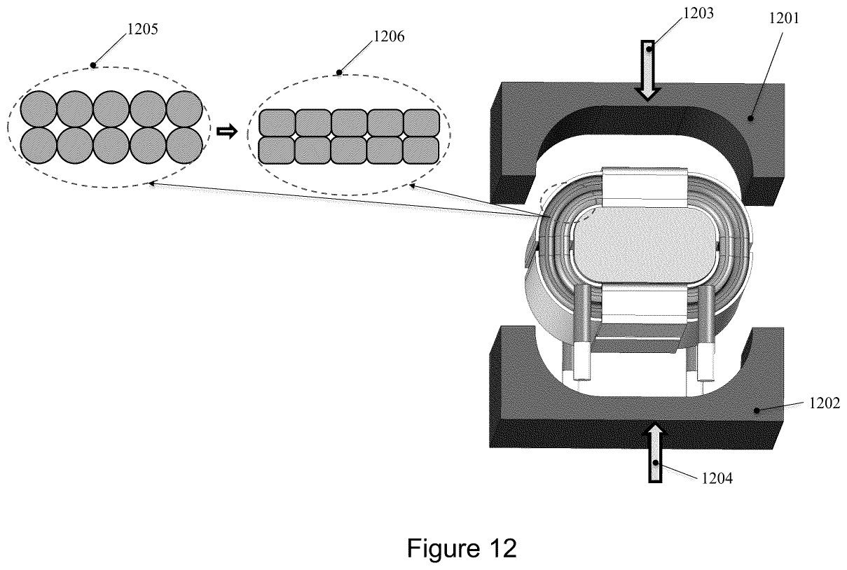

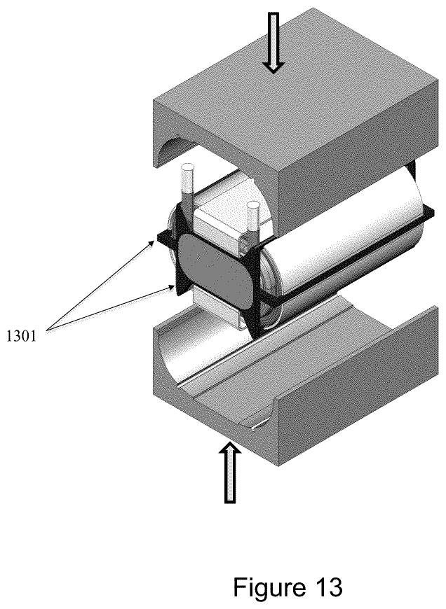

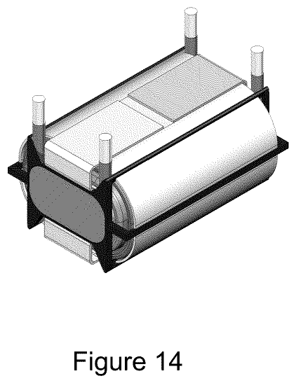

FIG. 12 is a perspective view of the magnetic device shown in FIG. 11 after a force pressing process is applied to the windings in accordance with various embodiments of the present disclosure. FIG. 13 is a perspective view of the magnetic device shown in FIG. 12 after a first injection molding process is applied to the winding section in accordance with various embodiments of the present disclosure. FIG. 14 is a perspective view of the magnetic device shown in FIG. 12 upon completion of the first injection molding process in accordance with various embodiments of the present disclosure.

As shown in FIG. 12, a pressing tool includes an upper portion 1201 and a lower portion 1202. In some embodiments, the upper portion 1201 is an upper portion of an injection mold, and the lower portion 1202 is a lower portion of the injection mold. As shown in FIG. 12, the top surface of the upper portion 1201 is flat, while its bottom surface is contoured to match the upper surface of the winding section. The bottom surface of the lower portion 1202 is also flat, and its top surface is contoured to match the lower surface of the winding section.

In the fabrication process, the winding section is positioned between the upper portion 1201 and the lower portion 1202. As indicated by arrows 1203 and 1204, mechanical pressure is applied to the winding section, reducing its volume and promoting intimate contact among the windings 130, 140, the central core pillar 125, and the heat sinks 113-118. The excess space within the winding structure is compressed. Prior to pressing, the dashed oval 1205 illustrates that the winding (e.g., winding 130) has a generally round cross-sectional shape. After pressing, as shown by the dashed oval 1206, the winding has a flattened profile with a flat top surface and a flat bottom surface. These flat surfaces enhance the contact between adjacent windings, thereby reducing the resistance of the winding.

As shown in FIG. 13, after an injection molding process is applied to the winding section shown in FIG. 12, components such as the central core pillar 125, the heat sinks 113-118, the windings 130, 140, and internal air gap pieces of the magnetic core are encapsulated by a suitable molding material 1301 and fixed into the shape of the winding section using high-temperature, high-pressure liquid molding materials.

In some embodiments, the injection molding process is a high-temperature, high-pressure integrated injection molding encapsulation process using plastic resins such as PPS, PBT and the like. Before the high-temperature liquid plastic resin is injected, the heat sinks 113-118 and windings 130, 140 are tightly compressed by the injection mold.

After being subjected to high pressure, the windings 130, 140, along with the thin heat sinks sandwiched on both sides, are compressed. Then, under tens of megapascals (MPa) of pressure, the high-temperature liquid plastic resin flows into the mold cavity and solidifies under high temperature and pressure, thereby forming the winding section shown in FIG. 14.

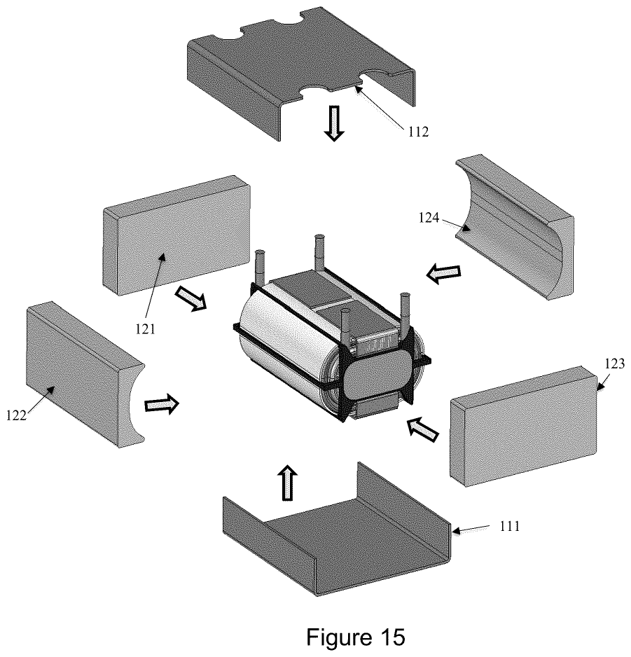

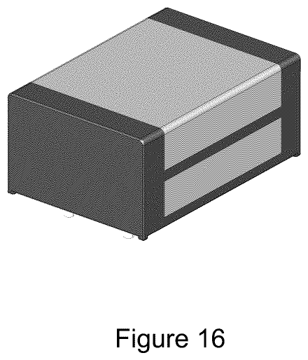

FIG. 15 is a perspective view of the magnetic device shown in FIG. 14 after a second injection molding process is applied to the winding section in accordance with various embodiments of the present disclosure. FIG. 16 is a perspective view of the magnetic device shown in FIG. 15 upon completion of the second injection molding process in accordance with various embodiments of the present disclosure.

After the winding section is formed in a single molding step shown in FIGS. 12-14, a secondary injection molding process is performed in combination with external components such as the magnetic core portions 121-124 and heat sinks 111-112. As shown in FIG. 16, this secondary injection molding process enables the flat surfaces of the heat sinks on both sides. As shown in FIG. 16, the heat sink 111 is exposed, and the heat sink 112 is partially exposed.

It should be noted that in the second injection molding process, the distribution and quantity of the molding material within the modular transformer can be precisely controlled through the design of the mold tool. By selectively applying pressure and configuring the internal geometry of the mold, certain regions can be tightly compressed, thereby eliminating space for the molding material to enter. Conversely, by intentionally incorporating cavities or voids within specific areas of the mold, the molding material is allowed to flow into and remain in those regions. This approach enables targeted encapsulation, optimized material usage, and enhanced thermal or mechanical performance based on the structural and functional requirements of the modular transformer.

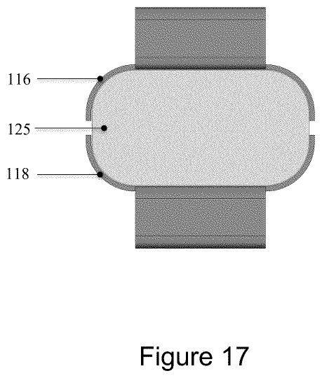

Referring back to FIG. 8, one example configuration of the inner heat sinks is illustrated in accordance with embodiments of the present disclosure. It should be understood, however, that this implementation is provided merely for illustrative purposes, and numerous variations may be employed without departing from the scope of the invention. For example, FIGS. 17-22 depict alternative embodiments and configurations of the inner heat sink, each demonstrating different structural features, orientations, and integration techniques. These variations highlight the flexibility of the design and the adaptability of the inner heat sink to meet diverse thermal management and packaging requirements.

FIG. 17 illustrates a cross-sectional view of a first implementation variation of the inner heat sink in accordance with various embodiments of the present disclosure. The inner heat sink configuration shown in FIG. 17 is similar to that shown in FIG. 8, and hence is not discussed in detail herein to avoid repetition.

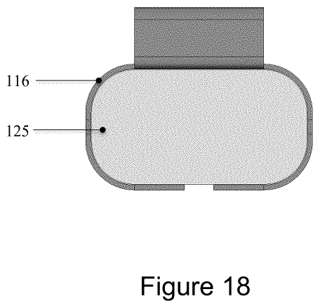

FIG. 18 illustrates a cross-sectional view of a second implementation variation of the inner heat sink in accordance with various embodiments of the present disclosure. The inner heat sink configuration shown in FIG. 18 is similar to that shown in FIG. 17 except that the central magnetic core pillar 125 is wrapped by one inner heat sink (e.g., inner heat sink 116). From the cross-sectional view, there is a narrow gap between two ends of the inner heat sink 116.

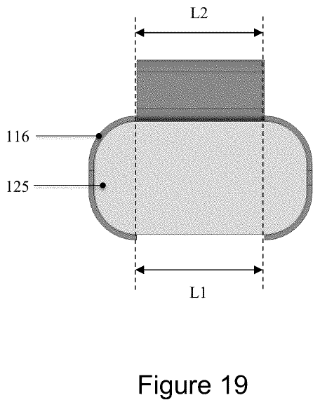

FIG. 19 illustrates a cross-sectional view of a third implementation variation of the inner heat sink in accordance with various embodiments of the present disclosure. The inner heat sink configuration shown in FIG. 19 is similar to that shown in FIG. 18 except that the gap between two ends of the inner heat sink 116 is wider than the narrow gap shown in FIG. 18. In some embodiments, the length L1 of the gap is equal to the length L2 of the upper portion of the inner heat sink 116.

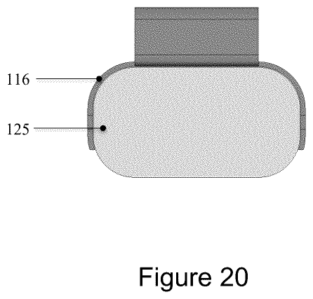

FIG. 20 illustrates a cross-sectional view of a fourth implementation variation of the inner heat sink in accordance with various embodiments of the present disclosure. The inner heat sink configuration shown in FIG. 20 is similar to that shown in FIG. 18 except that the gap between two ends of the inner heat sink is wider than the narrow gap shown in FIG. 18. From the cross-sectional view, the central magnetic core pillar 125 comprises a flat bottom, a flat top, a left sidewall, a right sidewall, an upper left curved portion connected between the left sidewall and the flat top, a lower left curved portion connected between the left sidewall and the flat bottom, an upper right curved portion connected between the right sidewall and the flat top, and a lower right curved portion connected between the right sidewall and the flat bottom.

In some embodiments, a bottom surface of the left end of the inner heat sink 116 is a level with the junction between the left sidewall and the lower left curved portion. A bottom surface of the right end of the inner heat sink 116 is a level with the junction between the right sidewall and the lower right curved portion.

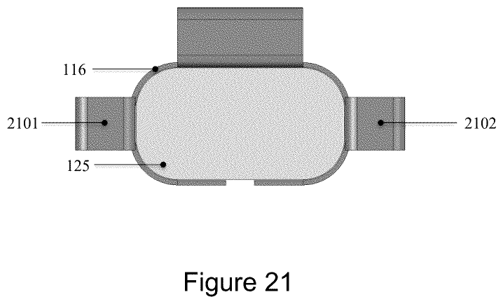

FIG. 21 illustrates a cross-sectional view of a fifth implementation variation of the inner heat sink in accordance with various embodiments of the present disclosure. The inner heat sink configuration shown in FIG. 21 is similar to that shown in FIG. 18 except that inner heat sink comprises two additional bendable portions 2101 and 2102. In the fabrication process of the modular transformer, the upper bendable portion is bent to have a direct contact with a top outer heat sink. The left bendable portion 2101 is bent to have a direct contact with a left outer heat sink placed over the left sidewall of the central magnetic core pillar 125. The right bendable portion 2102 is bent to have a direct contact with a right outer heat sink placed over the right sidewall of the central magnetic core pillar 125.

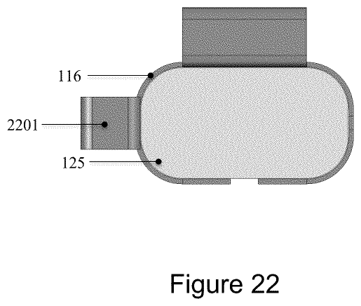

FIG. 22 illustrates a cross-sectional view of a sixth implementation variation of the inner heat sink in accordance with various embodiments of the present disclosure. The inner heat sink configuration shown in FIG. 22 is similar to that shown in FIG. 18 except that inner heat sink comprises one additional bendable portion 2201. In the fabrication process of the modular transformer, the upper bendable portion is bent to have a direct contact with a top outer heat sink. The left bendable portion 2201 is bent to have a direct contact with a left outer heat sink placed over the left sidewall of the central magnetic core pillar 125.

It should be understood that the six implementation variations, as illustrated in FIGS. 17-22, are not limited to the specific embodiments shown. The implementation variations may also be applied to other embodiments described in the present disclosure, where compatible, to achieve similar thermal management benefits. The features of the six implementation variations may be combined with various other structural or functional elements disclosed herein without departing from the scope of the invention.

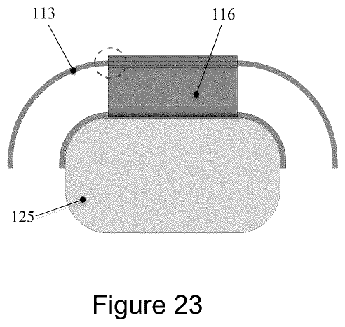

FIG. 23 illustrates a first arrangement of an inner heat sink and an outer heat sink in accordance with various embodiments of the present disclosure. In this arrangement, a lower portion of the inner heat sink 116 wraps around an upper portion of the central magnetic core pillar 125. A bendable section of the inner heat sink 116 is bent at a first right angle to form a sidewall portion that extends along the windings (not shown), and then bent at a second right angle to form an upper portion that extends over—and is in direct thermal contact with—the top surface of the outer heat sink 113.

It should be understood that the first arrangement of the inner heat sink and the outer heat sink, as illustrated in FIG. 23, is not limited to the specific embodiment shown. This arrangement may also be applied to other embodiments described in the present disclosure, where compatible, to achieve similar thermal management benefits. The features of the first arrangement may be combined with various other structural or functional elements disclosed herein without departing from the scope of the invention.

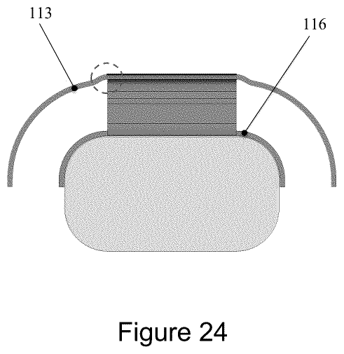

FIG. 24 illustrates a second arrangement of an inner heat sink and an outer heat sink in accordance with various embodiments of the present disclosure. In this arrangement, a lower portion of the inner heat sink 116 wraps around an upper portion of the central magnetic core pillar 125. A bendable section of the inner heat sink 116 is bent at a first right angle to form a sidewall portion that extends along the windings (not shown), and then bent at a second right angle to form an upper portion that extends beneath—and is in direct thermal contact with—the bottom surface of the outer heat sink 113.

It should be understood that the second arrangement of the inner heat sink and the outer heat sink, as illustrated in FIG. 24, is not limited to the specific embodiment shown. This arrangement may also be applied to other embodiments described in the present disclosure, where compatible, to achieve similar thermal management benefits. The features of the first arrangement may be combined with various other structural or functional elements disclosed herein without departing from the scope of the invention.

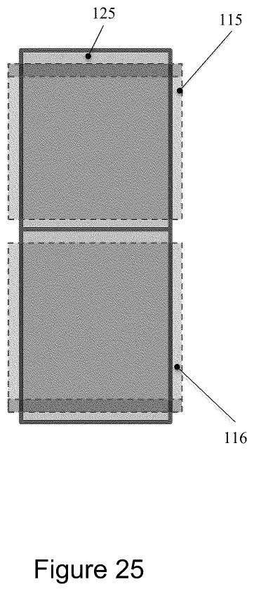

FIG. 25 illustrates a top view of a first arrangement of inner heat sinks and the central magnetic core pillar in accordance with various embodiments of the present disclosure. In this arrangement, the central magnetic core pillar 125 is a ferrite core without a gap. The inner heat sink 115 wraps around an upper portion of the central magnetic core pillar 125. From the top view, the inner heat sink 115 occupies the upper region of the central magnetic core pillar 125. The inner heat sink 116 occupies the lower of the central magnetic core pillar 125. As shown in FIG. 25, an unoccupied ferrite core area is present between the inner heat sink 115 and the inner heat sink 116.

It should be understood that the first arrangement of inner heat sinks and the central magnetic core pillar, as illustrated in FIG. 25, is not limited to the specific embodiment shown. This arrangement may also be applied to other embodiments described in the present disclosure, where compatible, to achieve similar thermal management benefits. The features of the first arrangement may be combined with various other structural or functional elements disclosed herein without departing from the scope of the invention.

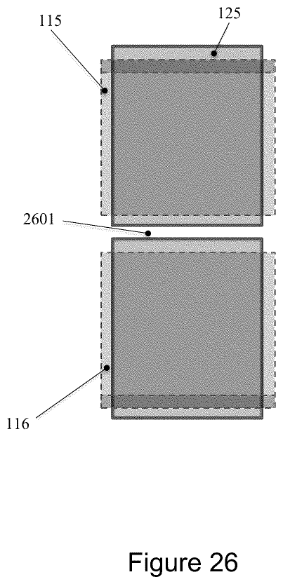

FIG. 26 illustrates a top view of a second arrangement of inner heat sinks and the central magnetic core pillar in accordance with various embodiments of the present disclosure. In this arrangement, the central magnetic core pillar 125 is a ferrite core having a gap 2601 located at its center. The inner heat sink 115 wraps around an upper portion of the central magnetic core pillar 125. From the top view, the inner heat sink 115 occupies the upper region of the central magnetic core pillar 125. The inner heat sink 116 occupies the lower of the central magnetic core pillar 125. As shown in FIG. 25, an unoccupied ferrite core area is present between the inner heat sink 115 and the inner heat sink 116. The gap 2601 is positioned at the center of the unoccupied ferrite core area.

It should be understood that the second arrangement of inner heat sinks and the central magnetic core pillar, as illustrated in FIG. 26, is not limited to the specific embodiment shown. This arrangement may also be applied to other embodiments described in the present disclosure, where compatible, to achieve similar thermal management benefits. The features of the first herein without departing from the scope of the invention.

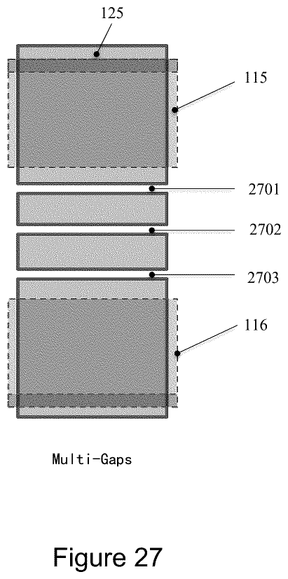

FIG. 27 illustrates a top view of a third arrangement of inner heat sinks and the central magnetic core pillar in accordance with various embodiments of the present disclosure. In this arrangement, the central magnetic core pillar 125 is a ferrite core having three gaps 2701, 2702 and 2703. The gap 2702 is located at the center of the central magnetic core pillar. In some embodiments, the distance from the gap 2701 to the gap 2702 is equal to the distance from the gap 2703 to the gap 2702.

It should be noted that the three gaps shown in FIG. 27 are merely illustrative and not intended to be limiting. In various embodiments, the central magnetic core pillar may include any number of gaps, depending on design requirements and performance considerations. The number, size, and placement of the gaps may be adjusted to achieve desired magnetic characteristics without departing from the scope of the present disclosure.

As shown in FIG. 27, the inner heat sink 115 wraps around an upper portion of the central magnetic core pillar 125. From the top view, the inner heat sink 115 occupies the upper region of the central magnetic core pillar 125. The inner heat sink 116 occupies the lower of the central magnetic core pillar 125. As shown in FIG. 25, an unoccupied ferrite core area is present between the inner heat sink 115 and the inner heat sink 116. The gaps 2702 is positioned at the center of the unoccupied ferrite core area.

It should be understood that the third arrangement of inner heat sinks and the central magnetic core pillar, as illustrated in FIG. 27, is not limited to the specific embodiment shown. This arrangement may also be applied to other embodiments described in the present disclosure, where compatible, to achieve similar thermal management benefits. The features of the first herein without departing from the scope of the invention.

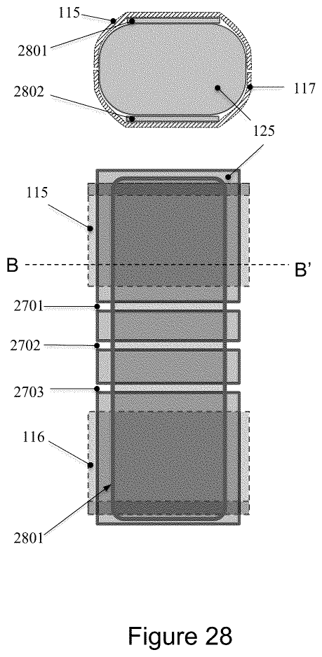

FIG. 28 illustrates a top view of a fourth arrangement of inner heat sinks and the central magnetic core pillar in accordance with various embodiments of the present disclosure. The upper portion shows a cross-section view along the line B-B′ shown in FIG. 28. The fourth arrangement shown in FIG. 28 is similar to the third arrangement shown in FIG. 27 except that two ceramic sheets 2801 and 2802 are placed between the central magnetic core pillar 125 and the inner heat sinks to aid in thermal dissipation.

As shown in FIG. 28, a first side of a first ceramic sheet 2801 is in contact with a flat upper surface of the central magnetic core pillar 125, and a second side of the first ceramic sheet 2801 is in contact with the inner heat sinks 115 and 116. A first side of a second ceramic sheet 2802 is in contact with a flat lower surface of the central magnetic core pillar 125, and a second side of the second ceramic sheet 2802 is in contact with the inner heat sinks 117 and 118.

The ceramic sheets 2801 and 2802 act as effective thermal interface devices, helping to transfer heat from the magnetic core pillar 125 to the inner heat sinks. Due to the high thermal conductivity of the ceramic sheets and insulating properties, the ceramic sheets 2801 and 2802 enhance the heat flow efficiency while preventing unwanted thermal effects on the magnetic core. This arrangement ensures improved thermal management, contributing to the overall stability and performance of the modular transformer.

It should be understood that the fourth arrangement of inner heat sinks and the central magnetic core pillar, as illustrated in FIG. 28, is not limited to the specific embodiment shown. This arrangement may also be applied to other embodiments described in the present disclosure, where compatible, to achieve similar thermal management benefits. The features of the first herein without departing from the scope of the invention.

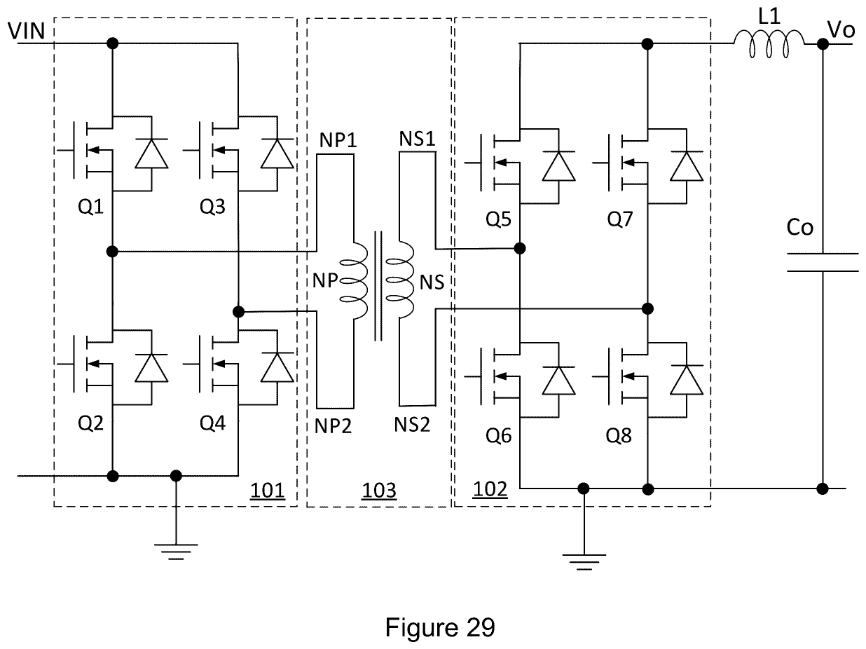

FIG. 29 illustrates a schematic diagram of a power converter including a modular transformer in accordance with various embodiments of the present disclosure. In some embodiments, the power converter is implemented as a full-bridge converter having an input terminal VIN and an output terminal Vo. The power converter comprises a primary side circuit 101, a modular transformer 103, a rectifier 102 and a filter connected in cascade between VIN and Vo. The modular transformer 103 may be implemented in any of the embodiments described above with reference to FIGS. 1 through 28.

The primary side circuit of the full-bridge converter comprises a first switch Q1 and a second switch Q2, a third switch Q3 and a fourth switch Q4. As shown in FIG. 29, the first switch Q1 and the second switch Q2 are connected in series between a first voltage bus and a second voltage bus. The third switch Q3 and the fourth switch Q4 are connected in series between the first voltage bus and the second voltage bus. The first voltage bus is coupled to the input terminal VIN. The second voltage bus is connected to ground.

A common node of the first switch Q1 and the second switch Q2 is connected to a first terminal NP1 of the primary winding NP of the modular transformer. A common node of the third switch Q3 and the fourth switch Q4 is connected to a second terminal NP2 of the primary winding NP of the modular transformer. Referring back to FIG. 1, either the winding 130 or the winding 140 can be implemented as the primary winding NP.

The secondary side circuit of the full-bridge converter comprises a rectifier 102 and a filter connected in cascade between the secondary winding NS of the modular transformer and the load. The rectifier 102 comprises a fifth switch Q5, a sixth switch Q6, a seventh switch Q7 and an eighth switch Q8. The filter comprises an inductor L1 and an output capacitor Co.

As shown in FIG. 29, the fifth switch Q5 and the sixth switch Q6 are connected in series between a third voltage bus and a fourth voltage bus. The seventh switch Q7 and the eighth switch Q8 are connected in series between the third voltage bus and the fourth voltage bus. The third voltage bus is coupled to the input of the filter. The fourth voltage bus is connected to ground.

A common node of the fifth switch Q5 and the sixth switch Q6 is connected to a first terminal NS1 of the second winding NS of the modular transformer. A common node of the seventh switch Q7 and the eighth switch Q8 is connected to a second terminal NS2 of the second winding NS of the modular transformer. The inductor L1 of the filter is connected between the third voltage bus and the output terminal Vo. The output capacitor Co is connected between the output terminal Vo and ground.

It should be noted that the modular transformer structure shown in FIG. 29 is merely an example. One person skilled in the art will recognize many alternatives, variations and modification. For example, the secondary side of the modular transformer may be a center tapped transformer winding. As a result, the secondary side may employ a synchronous rectifier formed by two switching elements. The operation principle of a synchronous rectifier coupled to a center tapped transformer winding is well known, and hence is not discussed in further detail herein to avoid repetition.

It should further be noted that the power topology of the full-bridge converter may be not only applied to the rectifier as shown in FIG. 29, but also applied to other secondary configurations, such as voltage doubler rectifiers, current doubler rectifiers, any combinations thereof and/or the like.

It should be noted that the diagram shown in FIG. 29 is merely an example, which should not unduly limit the scope of the claims. One of ordinary skill in the art would recognize many variations, alternatives, and modifications. For example, switches Q5-Q8 may be replaced by diodes to simplify the control of the rectifier 102.

In accordance with an embodiment, the switches of FIG. 29 (e.g., switches Q1-Q8) may be metal oxide semiconductor field-effect transistor (MOSFET) devices, bipolar junction transistor (BJT) devices, super junction transistor (SJT) devices, insulated gate bipolar transistor (IGBT) devices, gallium nitride (GaN) based power devices and/or the like.

It should be noted while FIG. 29 shows the switches are implemented as single n-type transistors, a person skilled in the art would recognize there may be many variations, modifications and alternatives. For example, depending on different applications and design needs, at least some of the switches may be implemented as p-type transistors. Furthermore, each switch shown in FIG. 29 may be implemented as a plurality of switches connected in parallel. Moreover, a capacitor may be connected in parallel with one switch to achieve zero voltage switching (ZVS)/zero current switching (ZCS).

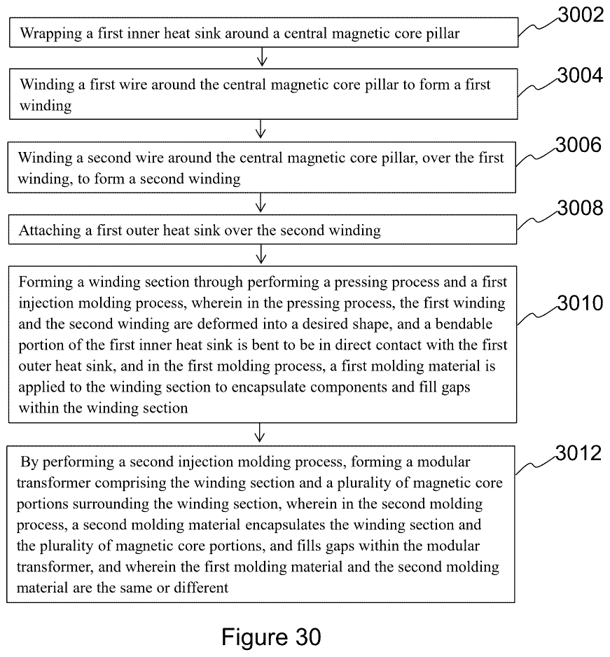

FIG. 30 illustrates a flow chart of a method for fabricating the modular transformer shown in FIG. 1 in accordance with various embodiments of the present disclosure. This flowchart shown in FIG. 30 is merely an example, which should not unduly limit the scope of the claims. One of ordinary skill in the art would recognize many variations, alternatives, and modifications. For example, various steps illustrated in FIG. 30 may be added, removed, replaced, rearranged and repeated.

At step 3002, a first inner heat sink is wrapped around a central magnetic core pillar.

At step 3004, a first wire is wound around the central magnetic core pillar to form a first winding.

At step 3006, a second wire is wound around the central magnetic core pillar, over the first winding, to form a second winding.

At step 3008, a first outer heat sink is attached over the second winding.

At step 3010, a winding section is formed through performing a pressing process and a first injection molding process. In the pressing process, the first winding and the second winding are deformed into a desired shape, and a bendable portion of the first inner heat sink is bent to be in direct contact with the first outer heat sink. In the first molding process, a first molding material is applied to the winding section to encapsulate components and fill gaps within the winding section.

At step 3012, by performing a second injection molding process, a modular transformer is formed. The modular transformer comprises the winding section and a plurality of magnetic core portions surrounding the winding section. In the second molding process, a second molding material encapsulates the winding section and the plurality of magnetic core portions, and fills gaps within the modular transformer, wherein the first molding material and the second molding material are the same or different.

In some embodiments, the first winding is a first single-layer winding, and wherein, after the pressing process is applied to the first winding, the first winding is deformed into a first flattened profile with a flat top surface and a flat bottom surface, and the second winding is a second single-layer winding, after the pressing process is applied to the second winding, the second winding is deformed into a second flattened profile with a flat top surface and a flat bottom surface.

The method further comprises wrapping a second inner heat sink around the central magnetic core pillar, wrapping a third inner heat sink around the central magnetic core pillar, wrapping a fourth inner heat sink around the central magnetic core pillar, and attaching a second outer heat sink over the second winding, wherein once the winding section is formed, a bendable portion of the second inner heat sink is bent to be in direct contact with the first outer heat sink, and bendable portions of the third inner heat sink and the fourth inner heat sink are bent to be in direct contact with the second outer heat sink.

In some embodiments, the first outer heat sink wraps around an upper portion of the second winding, the second outer heat sink wraps around a lower portion of the second winding, after the pressing process is applied to a bendable portion of the first inner heat sink, the first inner heat sink comprises a core-contacting portion, a vertical portion and an extended portion, and wherein the core-contacting portion wraps around a first portion of the central magnetic core pillar, and the extended portion of the first inner heat sink is in direct contact with the first outer heat sink, after the pressing process is applied to a bendable portion of the second inner heat sink, the second inner heat sink comprises a core-contacting portion, a vertical portion and an extended portion, and wherein the core-contacting portion of the second inner heat sink wraps around a second portion of the central magnetic core pillar, and the extended portion of the second inner heat sink is in direct contact with the first outer heat sink, after the pressing process is applied to a bendable portion of the third inner heat sink, the third inner heat sink comprises a core-contacting portion, a vertical portion and an extended portion, and wherein the core-contacting portion of the third inner heat sink wraps around a third portion of the central magnetic core pillar, and the extended portion of the third inner heat sink is in direct contact with the second outer heat sink, and after the pressing process is applied to a bendable portion of the fourth inner heat sink, the fourth inner heat sink comprises a core-contacting portion, a vertical portion and an extended portion, and wherein the core-contacting portion of the fourth inner heat sink wraps around a fourth portion of the central magnetic core pillar, and the extended portion of the fourth inner heat sink is in direct contact with the second outer heat sink.

The method further comprises placing a first sidewall core portion adjacent to a first sidewall of the winding section, a second sidewall core portion adjacent to a second sidewall of the winding section, a first terminal core portion adjacent to a first end of the winding section, a second terminal core portion adjacent to a second end of the winding section, a first exposed heat sink over the winding section and a second exposed heat sink beneath the winding section, and applying the second injection molding process to the first sidewall core portion, the second sidewall core portion, the first terminal core portion, the first terminal core portion, the winding section, the first exposed heat sink and the second exposed heat sink to form the modular transformer.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus comprising:
a central magnetic core pillar;
a first inner heat sink including a core-contacting portion, a vertical portion and an extended portion, wherein the core-contacting portion wraps around a first portion of the central magnetic core pillar;
a first winding wound around the central magnetic core pillar, wherein the first inner heat sink is between the first winding and the central magnetic core pillar;
a second winding wound around the central magnetic core pillar, wherein the first winding is between the second winding and the central magnetic core pillar;
a first outer heat sink over the second winding, wherein the vertical portion of the first inner heat sink is adjacent to outermost turns of the first winding and the second winding, and the extended portion of the first inner heat sink is in direct contact with the first outer heat sink; and
a plurality of magnetic core portions located around an outer perimeter of the second winding, wherein the central magnetic core pillar and the plurality of magnetic core portions form a magnetic path of a transformer.

2. The apparatus of claim 1, further comprising:
a second outer heat sink, wherein the first outer heat sink wraps around an upper portion of the second winding, and the second outer heat sink wraps around a lower portion of the second winding;
a second inner heat sink including a core-contacting portion, a vertical portion and an extended portion, wherein the core-contacting portion wraps around a second portion of the central magnetic core pillar, and the extended portion of the second inner heat sink is in direct contact with the first outer heat sink;
a third inner heat sink including a core-contacting portion, a vertical portion and an extended portion, wherein the core-contacting portion wraps around a third portion of the central magnetic core pillar, and the extended portion of the third inner heat sink is in direct contact with the second outer heat sink; and
a fourth inner heat sink including a core-contacting portion, a vertical portion and an extended portion, wherein the core-contacting portion wraps around a fourth portion of the central magnetic core pillar, and the extended portion of the fourth inner heat sink is in direct contact with the second outer heat sink.

3. The apparatus of claim 2, further comprising:
a first ceramic sheet having a first side in contact with a flat upper surface of the central magnetic core pillar and a second side in contact with the first inner heat sink and the second inner heat sink; and
a second ceramic sheet having a first side in contact with a flat lower surface of the central magnetic core pillar and a second side in contact with the third inner heat sink and the fourth inner heat sink.

4. The apparatus of claim 2, wherein:
the plurality of magnetic core portions comprises a first sidewall core portion, a second sidewall core portion, a first terminal core portion and a second terminal core portion, and wherein:
the first sidewall core portion and the second sidewall core portion are shaped to follow a profile of the second winding; and
the first terminal core portion and the second terminal core portion are in contact with two terminals of the central magnetic core pillar, respectively.

5. The apparatus of claim 4, further comprising:
a first exposed heat sink and a second exposed heat sink, wherein:
a center portion of the first exposed heat sink is in direct contact with the extended portion of the first inner heat sink and the extended portion of the second inner heat sink;
a first sidewall portion of the first exposed heat sink is in direct contact with the first sidewall core portion;
a second sidewall portion of the first exposed heat sink is in direct contact with the second sidewall core portion;
a center portion of the second exposed heat sink is in direct contact with the extended portion of the third inner heat sink and the extended portion of the fourth inner heat sink;
a first sidewall portion of the second exposed heat sink is in direct contact with the first sidewall core portion; and
a second sidewall portion of the second exposed heat sink is in direct contact with the second sidewall core portion.

6. The apparatus of claim 5, wherein:
the central magnetic core pillar, the first inner heat sink, the second inner heat sink, the third inner heat sink, the fourth inner heat sink, the first winding, the second winding, the first outer heat sink and the second outer heat sink collectively form a winding section, and wherein a first molding material is applied to the winding section to encapsulate components and fill gaps within the winding section.

7. The apparatus of claim 6, wherein:
the winding section, the first exposed heat sink, the second exposed heat sink, the first sidewall core portion, the second sidewall core portion, the first terminal core portion and the second terminal core portion collectively form the transformer, and wherein a second molding material is applied to fill gaps between components of the transformer and to encapsulate the magnetic core portions.

8. The apparatus of claim 1, wherein:
the first winding is a first single-layer winding, and wherein from a cross-sectional view, the first winding has a flattened profile with a flat top surface and a flat bottom surface; and
the second winding is a second single-layer winding, and wherein from a cross-sectional view, the second winding has a flattened profile with a flat top surface and a flat bottom surface.

9. The apparatus of claim 1, wherein:
the extended portion of the first inner heat sink is in direct contact with a top surface of the first outer heat sink.

10. The apparatus of claim 1, wherein:
the extended portion of the first inner heat sink is in direct contact with a bottom surface of the first outer heat sink.

11. The apparatus of claim 1, wherein:
the first inner heat sink includes the core-contacting portion, a first bendable portion comprising the vertical portion and the extended portion, and a second bendable portion, wherein:
the second bendable portion is configured similarly to the first bendable portion;
the first bendable portion is bent to have a direct contact with a top outer heat sink; and
the second bendable portion is bent to have a direct contact with a left outer heat sink placed over a left sidewall of the central magnetic core pillar.

12. The apparatus of claim 1, wherein:
the first inner heat sink includes the core-contacting portion, a first bendable portion comprising the vertical portion and the extended portion, a second bendable portion and a third bendable portion, wherein:
the second bendable portion and the third bendable portion are configured similarly to the first bendable portion;
the first bendable portion is bent to have a direct contact with a top outer heat sink;
the second bendable portion is bent to have a direct contact with a left outer heat sink placed over a left sidewall of the central magnetic core pillar; and
the third bendable portion is bent to have a direct contact with a right outer heat sink placed over a right sidewall of the central magnetic core pillar.

13. A system comprising:
a primary switch network coupled to an input voltage source;
a secondary switch network coupled to a filter; and
a modular transformer having a first terminal and a second terminal connected to the primary switch network, and a third terminal and a fourth terminal connected to the secondary switch network, wherein the modular transformer comprises:
a central magnetic core pillar;
a first inner heat sink including a core-contacting portion, a vertical portion and an extended portion, wherein the core-contacting portion wraps around a first portion of the central magnetic core pillar;
a first winding wound around the central magnetic core pillar, wherein the first inner heat sink is between the first winding and the central magnetic core pillar;
a second winding wound around the central magnetic core pillar, wherein the first winding is between the second winding and the central magnetic core pillar;
a first outer heat sink over the second winding, wherein the vertical portion of the first inner heat sink is adjacent to outermost turns of the first winding and the second winding, and the extended portion of the first inner heat sink is in direct contact with the first outer heat sink; and
a plurality of magnetic core portions located around an outer perimeter of the second winding, wherein the central magnetic core pillar and the plurality of magnetic core portions form a magnetic path of a transformer.

14. The system of claim 13, further comprising:
a second outer heat sink, wherein the first outer heat sink wraps around an upper portion of the second winding, and the second outer heat sink wraps around a lower portion of the second winding;
a second inner heat sink including a core-contacting portion, a vertical portion and an extended portion, wherein the core-contacting portion wraps around a second portion of the central magnetic core pillar, and the extended portion of the second inner heat sink is in direct contact with the first outer heat sink;
a third inner heat sink including a core-contacting portion, a vertical portion and an extended portion, wherein the core-contacting portion wraps around a third portion of the central magnetic core pillar, and the extended portion of the third inner heat sink is in direct contact with the second outer heat sink;
a fourth inner heat sink including a core-contacting portion, a vertical portion and an extended portion, wherein the core-contacting portion wraps around a fourth portion of the central magnetic core pillar, and the extended portion of the fourth inner heat sink is in direct contact with the second outer heat sink; and
a first exposed heat sink and a second exposed heat sink, wherein:
the plurality of magnetic core portions comprises a first sidewall core portion, a second sidewall core portion, a first terminal core portion and a second terminal core portion;
a center portion of the first exposed heat sink is in direct contact with the extended portion of the first inner heat sink and the extended portion of the second inner heat sink;
a first sidewall portion of the first exposed heat sink is in direct contact with the first sidewall core portion;
a second sidewall portion of the first exposed heat sink is in direct contact with the second sidewall core portion;
a center portion of the second exposed heat sink is in direct contact with the extended portion of the third inner heat sink and the extended portion of the fourth inner heat sink;
a first sidewall portion of the second exposed heat sink is in direct contact with the first sidewall core portion; and
a second sidewall portion of the second exposed heat sink is in direct contact with the second sidewall core portion.

15. The system of claim 13, wherein:
the first winding is a first single-layer winding, and wherein from a cross-sectional view, the first winding has a flattened profile with a flat top surface and a flat bottom surface; and
the second winding is a second single-layer winding, and wherein from a cross-sectional view, the second winding has a flattened profile with a flat top surface and a flat bottom surface.

16. A method comprising:
wrapping a first inner heat sink around a central magnetic core pillar;
winding a first wire around the central magnetic core pillar to form a first winding;
winding a second wire around the central magnetic core pillar, over the first winding, to form a second winding;
attaching a first outer heat sink over the second winding;
forming a winding section through performing a pressing process and a first injection molding process, wherein in the pressing process, the first winding and the second winding are deformed into a desired shape, and a bendable portion of the first inner heat sink is bent to be in direct contact with the first outer heat sink, and in the first molding process, a first molding material is applied to the winding section to encapsulate components and fill gaps within the winding section; and
by performing a second injection molding process, forming a modular transformer comprising the winding section and a plurality of magnetic core portions surrounding the winding section, wherein in the second molding process, a second molding material encapsulates the winding section and the plurality of magnetic core portions, and fills gaps within the modular transformer, and wherein the first molding material and the second molding material are the same or different.

17. The method of claim 16, wherein:
the first winding is a first single-layer winding, and wherein, after the pressing process is applied to the first winding, the first winding is deformed into a first flattened profile with a flat top surface and a flat bottom surface; and
the second winding is a second single-layer winding, after the pressing process is applied to the second winding, the second winding is deformed into a second flattened profile with a flat top surface and a flat bottom surface.

18. The method of claim 16, further comprising:
wrapping a second inner heat sink around the central magnetic core pillar;
wrapping a third inner heat sink around the central magnetic core pillar;
wrapping a fourth inner heat sink around the central magnetic core pillar; and
attaching a second outer heat sink over the second winding, wherein:
once the winding section is formed, a bendable portion of the second inner heat sink is bent to be in direct contact with the first outer heat sink, and bendable portions of the third inner heat sink and the fourth inner heat sink are bent to be in direct contact with the second outer heat sink.

19. The method of claim 18, wherein:
the first outer heat sink wraps around an upper portion of the second winding;
the second outer heat sink wraps around a lower portion of the second winding;
after the pressing process is applied to a bendable portion of the first inner heat sink, the first inner heat sink comprises a core-contacting portion, a vertical portion and an extended portion, and wherein the core-contacting portion wraps around a first portion of the central magnetic core pillar, and the extended portion of the first inner heat sink is in direct contact with the first outer heat sink;
after the pressing process is applied to a bendable portion of the second inner heat sink, the second inner heat sink comprises a core-contacting portion, a vertical portion and an extended portion, and wherein the core-contacting portion of the second inner heat sink wraps around a second portion of the central magnetic core pillar, and the extended portion of the second inner heat sink is in direct contact with the first outer heat sink;
after the pressing process is applied to a bendable portion of the third inner heat sink, the third inner heat sink comprises a core-contacting portion, a vertical portion and an extended portion, and wherein the core-contacting portion of the third inner heat sink wraps around a third portion of the central magnetic core pillar, and the extended portion of the third inner heat sink is in direct contact with the second outer heat sink; and
after the pressing process is applied to a bendable portion of the fourth inner heat sink, the fourth inner heat sink comprises a core-contacting portion, a vertical portion and an extended portion, and wherein the core-contacting portion of the fourth inner heat sink wraps around a fourth portion of the central magnetic core pillar, and the extended portion of the fourth inner heat sink is in direct contact with the second outer heat sink.

20. The method of claim 18, further comprising:
placing a first sidewall core portion adjacent to a first sidewall of the winding section, a second sidewall core portion adjacent to a second sidewall of the winding section, a first terminal core portion adjacent to a first end of the winding section, a second terminal core portion adjacent to a second end of the winding section, a first exposed heat sink over the winding section and a second exposed heat sink beneath the winding section; and
applying the second injection molding process to the first sidewall core portion, the second sidewall core portion, the first terminal core portion, the first terminal core portion, the winding section, the first exposed heat sink and the second exposed heat sink to form the modular transformer.
